(19) United States
(12) Patent Application Publication
(10) Pub. No.: US 2025/0293462 A1
(43) Pub. Date: Sep. 18, 2025

(54) FINE ALIGNMENT ADAPTER FOR ALIGNING AN INFORMATION HANDLING RESOURCE WITH A CONNECTOR

(71) Applicant: Dell Products L.P., Round Rock, TX (US)

(72) Inventors: Eduardo ESCAMILLA, Round Rock, TX (US); Robert G. BASSMAN, Dalton, MA (US); Juan M. GONZALEZ, Round Rock, TX (US)

(73) Assignee: Dell Products L.P., Round Rock, TX (US)

(21) Appl. No.: 18/605,204

(22) Filed: Mar. 14, 2024

(51) Int. Cl. H01R 13/631; H01R 12/72

(52) U.S. Cl. CPC H01R 13/631; H01R 12/721

(57) ABSTRACT

An alignment adapter may include a base structure configured to couple to a housing adapter and an alignment arm extending from the base structure, wherein the alignment arm is configured to align an information handling resource board with a connector.

### TECHNICAL FIELD

The present disclosure relates in general to information handling systems, and more particularly to a fine alignment adapter for a connector in an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may often include power supply units to provide power to information handling resources. Such power supply units may be inserted within information handling systems and coupled to information handling resources via connectors. Form factors for such power supply units often vary in width. For example, a power supply unit with a higher power rating may utilize a wider power supply board to interface with a connector than a power supply unit with a lower power rating. However, industry standard connectors may only be compatible with power supply units having a particular width, and incompatible with power supply units having smaller widths. Accordingly, a fine alignment adapter to enable compatibility of a standard connector with power supply units having varying widths may be desirable.

### SUMMARY

In accordance with the teachings of the present disclosure, the disadvantages and problems associated with existing approaches to aligning power supply units having varying widths with a standard connector may be reduced or eliminated.

In accordance with embodiments of the present disclosure, an alignment adapter may include a base structure configured to couple to a housing adapter and an alignment arm extending from the base structure, wherein the alignment arm is configured to align an information handling resource board with a connector.

In accordance with embodiments of the present disclosure, an information handling system may include a connector, an information handling resource board, and an alignment adapter. The connector may be configured to couple the information handling resource board to another information handling resource, and the information handling resource board may be configured to couple to the connector. The alignment adapter may include a base structure configured to couple to a housing adapter of the information handling system and an alignment arm configured to align the information handling resource board with the connector.

In accordance with embodiments of the present disclosure, a method of making an alignment adapter may include forming a base structure configured to couple to a housing adapter, and forming an alignment arm extending from the base structure, wherein the alignment arm is configured to align an information handling resource board with a connector.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a front elevation view of an example information handling system, in accordance with embodiments of the present disclosure;

FIG. 2 illustrates a plan view of an example power supply board coupled to an example connector of an example information handling system, in accordance with embodiments of the present disclosure;

FIG. 3 illustrates a plan view of another example power supply board coupled to an example connector of an example information handling system, in accordance with embodiments of the present disclosure;

FIG. 4 illustrates a perspective view of an example fine alignment adapter, in accordance with embodiments of the present disclosure;

FIG. 5 illustrates a perspective view of the fine alignment adapter of FIG. 4 coupled to an example housing adapter, in accordance with embodiments of the present disclosure;

FIG. 6 illustrates a perspective view of selected portions of an example power supply board interfacing with an example fine alignment adapter and with an example connector of an example information handling system; and

FIG. 7 illustrates a plan view of selected portions of an example power supply board interfacing with an example fine alignment adapter of and with an example connector of an example information handling system, in accordance with embodiments of the present disclosure.

### DETAILED DESCRIPTION

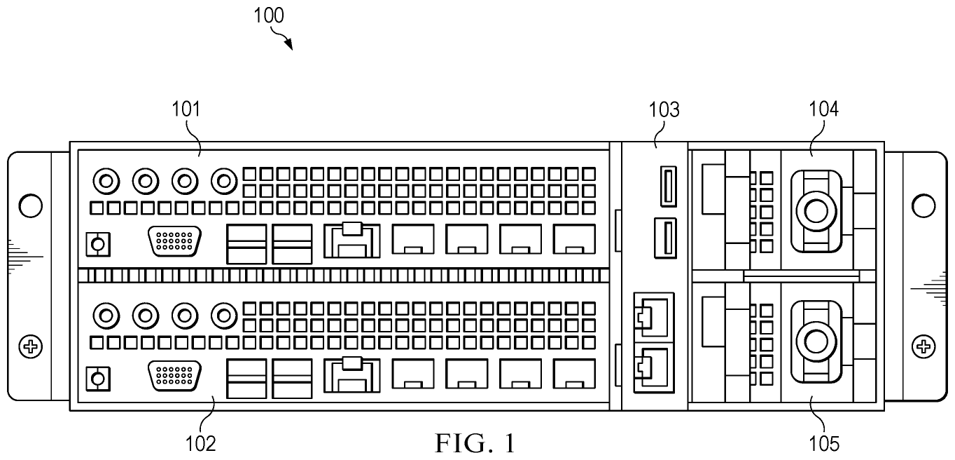

Preferred embodiments and their advantages are best understood by reference to FIGS. 1 through 7, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal data assistant (PDA), a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, buses, memories, I/O devices and/or interfaces, storage resources, network interfaces, motherboards, integrated circuit packages; electro-mechanical devices (e.g., air movers), displays, and power supplies.

FIG. 1 illustrates a front elevation view of an example information handling system 100, in accordance with embodiments of the present disclosure. Information handling system 100 may comprise any suitable number of information handling resources, such as information handling resources 101, 102, and 103, and power supply units 104 and 105. In some embodiments, power supply units 104 and 105 may each be inserted from the same edge of information handling system 100, and the power outputs of the power supply units may be on the same side of information handling system 100 as power ports of information handling resources 101, 102, and 103. In some embodiments, each of power supply units 104 and 105 may be inserted within respective housings of information handling system 100 and may be coupled to corresponding connectors. In some embodiments, the connectors may provide signal pins and power pins to enable power supply units 104 and 105 to communicate with and provide power to information handling resources 101, 102, and 103 of information handling system 100.

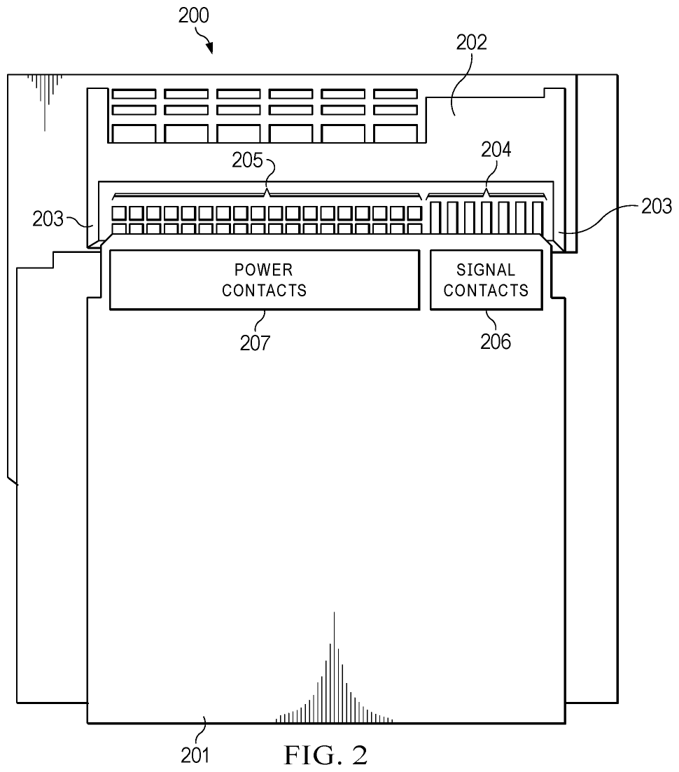

FIG. 2 illustrates a plan view of an example power supply board 201 coupled to an example connector 202 of an example information handling system 200, with a top portion of connector 202 removed for purposes of exposition, in accordance with embodiments of the present disclosure. Connector 202 may comprise chamfers 203, signal contacts 204, and power contacts 205. Power supply board 201 may comprise signal contacts 206 and power contacts 207. In some embodiments, chamfers 203 may interface with edges of power supply board 201 to provide fine alignment between power supply board 201 and connector 202. In some embodiments, chamfers 203 may align signal contacts 204 of connector 202 with signal contacts 206 of power supply board 201, and may align power contacts 205 of connector 202 with power contacts 207 of power supply board 201.

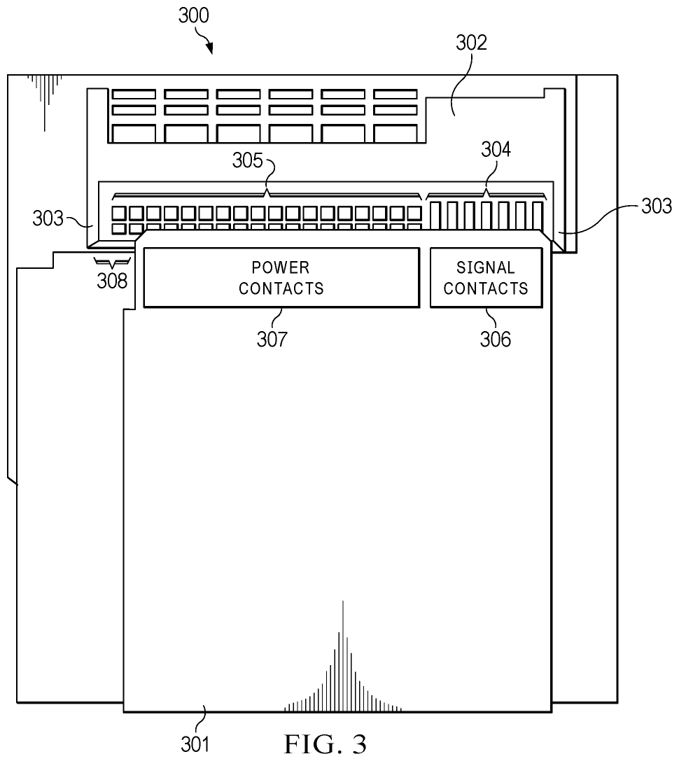

FIG. 3 illustrates a plan view of another example power supply board 301 coupled to example connector 302 of an example information handling system 300, with a top portion of connector 302 removed for purposes of exposition, in accordance with embodiments of the present disclosure. Connector 302 may comprise chamfers 303, signal contacts 304, and power contacts 305. Power supply board 301 may comprise signal contacts 306 and power contacts 307. As shown in FIG. 3, a width of power supply board 301 may be less than a width of connector 302, such that power supply board 301 may not be in physical communication with both chamfers 303 of connector 302 at the same time. In some embodiments, the width of power supply board 301 may be a particular amount 308 less than the width of connector 302. As a result, signal contacts 304 and power contacts 305 of connector 302 may misalign with signal contacts 306 and power contacts 307 of power supply board 301, respectively, such that connector 302 may not properly register power supply board 301.

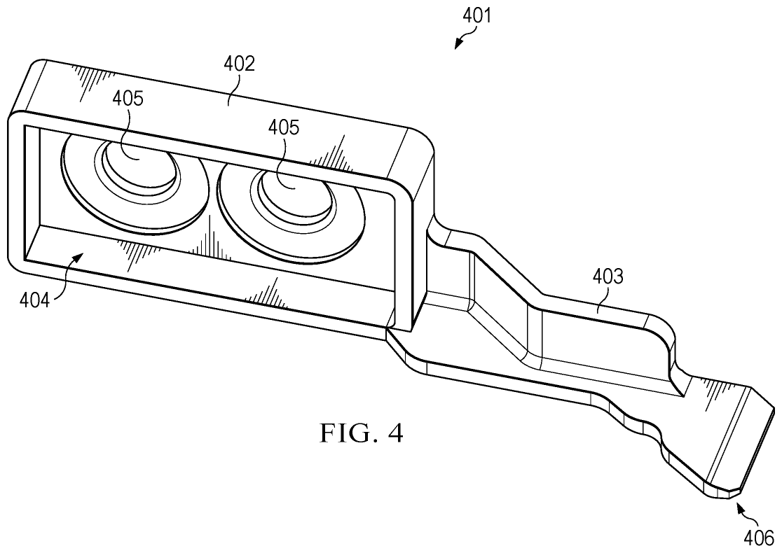

FIG. 4 illustrates a perspective view of an example fine alignment adapter 401, in accordance with embodiments of the present disclosure. As described further below, fine alignment adapter 401 may be configured to interface with a power supply board having a width less than that of a connector to enable fine alignment of the power supply board with the connector. As shown in FIG. 4, fine alignment adapter 401 may comprise a base structure 402 and an alignment arm 403. Base structure 402 may comprise a recess 404, which may comprise a number of holes 405. Alignment arm 403 may extend from base structure 402 and may comprise chamfer 406. As described further below, alignment arm 403 may interface with a power supply board having a smaller width than that of a connector in order to enable fine alignment of the power supply board and connector. In some embodiments, chamfer 406 may be substantially similar to a chamfer of the connector. While FIG. 4 shows base structure 402 as substantially rectangular in shape and recess 404 comprising two holes 405, base structure 402 may have any suitable shape and recess 404 may comprise any suitable number of holes 405.

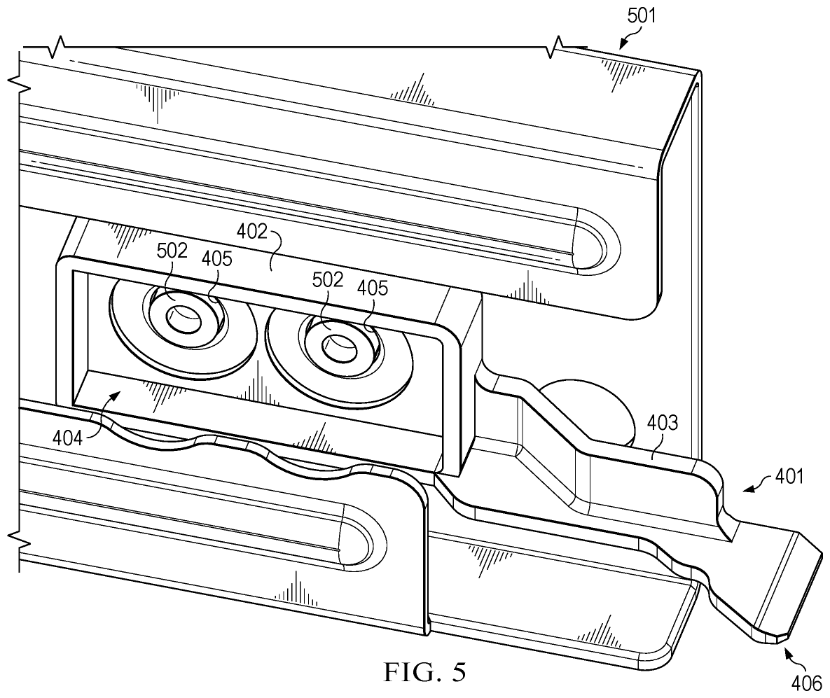

As shown in FIG. 5, fine alignment adapter 401 may mechanically couple to a housing adapter 501 via holes 405 of fine alignment adapter 401 and protrusions 502 of housing adapter 501. As described further below, housing adapter 501 may mechanically couple to a housing structure configured to house a power supply unit of a particular width such that the housing structure may accommodate a power supply unit having a shorter width.

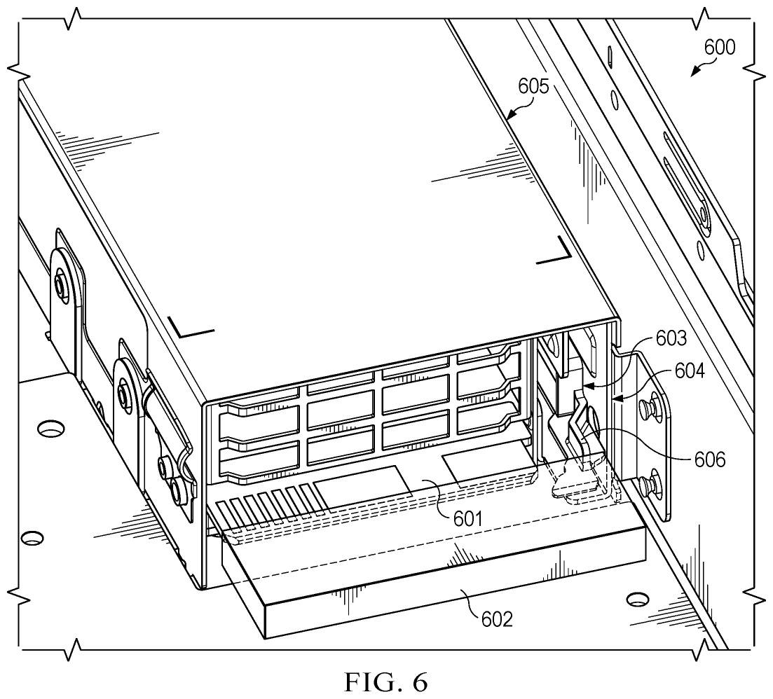

FIG. 6 illustrates a perspective view of selected portions of an example information handling system 600 comprising an example power supply board 601 interfacing with an example connector 602 and an example fine alignment adapter 603, in accordance with embodiments of the present disclosure. As shown in FIG. 6, fine alignment adapter 603 may mechanically couple to housing adapter 604, which may couple to housing structure 605 such that housing structure 605 may accommodate power supply board 601, which may have a smaller width than a power supply board that housing structure 605 may typically house. Fine alignment adapter 602 may couple to housing adapter 604 such that alignment arm 606 extends into connector 602. Fine alignment adapter 603 may thus interface with power supply board 601 to provide fine alignment of power supply board 601 and connector 602.

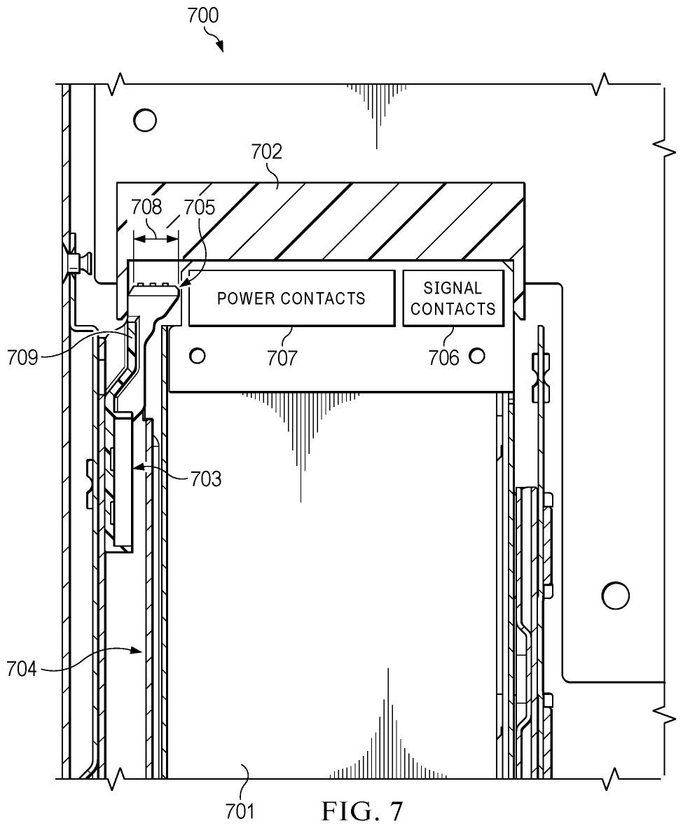

FIG. 7 illustrates a plan view of selected portions of an example information handling system 700 comprising an example power supply board 701 interfacing with an example connector 702 and an example fine alignment adapter 703, with a top portion of a housing structure and connector 702 removed for purposes of exposition, in accordance with embodiments of the present disclosure. As shown in FIG. 7, fine alignment adapter 703 may couple to housing adapter 704 and may provide fine alignment of power supply board 701 and connector 702. For example, chamfer 705 of fine alignment adapter 703 may align signal contacts of connector 702 with signal contacts 706 of power supply board 701, and may align power contacts of connector 702 with power contacts 707 of power supply board 701. In some embodiments, a width 708 of alignment arm 709 of fine alignment adapter 703 may be substantially equal to an amount by which a width of power supply board 701 is less than a width of connector 702.

Although the foregoing contemplates using a fine alignment adapter as disclosed herein to enable alignment of a power supply board and connector, one of ordinary skill in the art would understand that the fine alignment adapter as disclosed herein may be used in any other suitable application in which it is desired to interface an information handling resource with a connector, e.g., when an information handling resource board may require alignment of all of its pins with pins of the connector.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. An alignment adapter comprising:
a base structure configured to couple to a housing adapter; and
an alignment arm extending from the base structure, wherein the alignment arm is configured to align an information handling resource board with a connector.

2. The alignment adapter of claim 1, wherein the base structure comprises at least one hole configured to mechanically couple to at least one protrusion of the housing adapter.

3. The alignment adapter of claim 1, wherein the alignment arm comprises a chamfer configured to align the information handling resource board with the connector.

4. The alignment adapter of claim 3, wherein the chamfer of the alignment arm is substantially similar to a chamfer of the connector.

5. The alignment adapter of claim 1, wherein the alignment arm is further configured to align signal contacts of the information handling resource board with signal contacts of the connector, and align power contacts of the information handling resource board with power contacts of the connector.

6. The alignment adapter of claim 1, wherein a width of the alignment arm is substantially equal to an amount that the information handling resource board is short of a width of the connector.

7. An information handling system comprising:
a connector configured to couple an information handling resource board to another information handling resource;
the information handling resource board configured to couple to the connector; and
an alignment adapter comprising:
a base structure configured to couple to a housing adapter of the information handling system; and
an alignment arm configured to align the information handling resource board with the connector.

8. The information handling system of claim 7, wherein the housing adapter is configured to couple to a housing structure of the information handling system.

9. The information handling system of claim 7, wherein the base structure comprises at least one hole, wherein the at least one hole is configured to mechanically couple to at least one protrusion of the housing adapter.

10. The information handling system of claim 7, wherein the alignment arm comprises a chamfer configured to align the information handling resource board with the connector.

11. The information handling system of claim 10, wherein the chamfer of the alignment arm is substantially similar to a chamfer of the connector.

12. The information handling system of claim 7, wherein the alignment arm is further configured to align signal contacts of the information handling resource board with signal contacts of the connector, and align power contacts of the information handling resource board with power contacts of the connector.

13. The information handling system of claim 7, wherein a width of the alignment arm is substantially equal to an amount that the information handling resource board is short of a width of the connector.

14. A method of making an alignment adapter, the method comprising:
forming a base structure configured to couple to a housing adapter; and
forming an alignment arm extending from the base structure, wherein the alignment arm is configured to align an information handling resource board with a connector.

15. The method of claim 14, wherein the base structure comprises at least one hole in the structure configured to mechanically couple to at least one protrusion of the housing adapter.

16. The method of claim 14, wherein the alignment arm comprises a chamfer configured to align the information handling resource board with the connector.

17. The method of claim 16, wherein the chamfer of the alignment arm is substantially similar to a chamfer of the connector.

18. The method of claim 14, wherein the alignment arm is further configured to align signal contacts of the information handling resource board with signal contacts of the connector, and align power contacts of the information handling resource board with power contacts of the connector.

19. The method of claim 14, wherein a width of the alignment arm is substantially equal to an amount that the information handling resource board is short of a width of the connector.
